(19) United States
(12) Patent Application Publication
(10) Pub. No.: US 2016/0055758 A1
(43) Pub. Date: Feb. 25, 2016

(54) DELIVERING TO A USER A BIOMETRIC DISPLAY THAT COMMUNICATES HEALTH AND FITNESS PERFORMANCE RELATED INFORMATION ABOUT THE USER

(71) Applicant: Richard FRANCIS, Los Angeles, CA (US)

(72) Inventor: Richard FRANCIS, Los Angeles, CA (US)

(21) Appl. No.: 13/117,404

(22) Filed: May 27, 2011

Related U.S. Application Data
(60) Provisional application No. 61/349,129, filed on May 27, 2010.

(51) Int. Cl. G09B 19/00; G09B 7/00; G06F 3/0484; G09B 5/02; G06T 19/20; G06F 3/0481

(52) U.S. Cl. CPC G09B 19/00; G06T 19/20; G06F 3/04817; G06F 3/04847; G09B 5/02; G09B 7/00; G06T 2200/24

(57) ABSTRACT

The instant application describes a method for delivering to a user a biometric display containing a graphic representation of the user that communicates health related information about the user. The method includes steps of receiving via a communication network information associated with physical characteristics of the user and health related information associated with the user and generating a biometric display of the user based on the received physical characteristics associated with the user. The biometric display represents a virtual persona of the user tailored toward the received physical characteristics associated with the user. The method also includes steps of generating health parameters based on the received health related information associated with the user and associating the health parameters with their respective body parts on the biometric display. The health parameters communicate to the user health related information regarding their respective body part on the biometric display. The method also includes a step of delivering to the user via the communication network the biometric display along with the associative health parameters.

### RELATED APPLICATIONS

100011 This application claims the benefit of priority to U.S. Provisional Patent Application No. 61/349,129, filed on May 27, 2010, the contents of which are herein incorporated by reference in their entirety.

### TECHNICAL FIELD

The present subject matter relates to techniques and equipment to deliver to a user a biometric display containing a graphic representation of the user that communicates health and fitness performance related information about the user.

### BACKGROUND

Dissemination of biometric, performance-related and healthcare information to individual people has been limited to numbers, graphs and charts and primarily statistical displays that require interpretation and explanation from a doctor, nurse, healthcare professional, nutritionist, insurance provider, coach or other qualified person. Technologies have emerged and have been continually developed since the advent of the Internet age that provide for the utilization of virtual environments created in on-line resources, such as internet-based games or social environments, that enable people to interact in the virtual environment with a high degree of anonymity limited only by the degree of personal information provided by each participant in the virtual environment. Graphic representations of each participant are frequently employed to simulate physical interactions between the participants in the virtual environment. Such graphic representations are typically virtual personas and may or may not be anthropomorphic. Such anthropomorphic graphic representations coupled with a biometric input/output data display process are referred to herein as a “biometric display.” Examples of virtual personas or virtual representation of a particular person that is tailored to user-selected or predetermined sensory characteristics, such as physical (e.g., representative of hair, eye color, height, weight, body shape, clothes, etc.), emotional (e.g., happy, sad, quizzical, etc.) are abundant in a plethora of Internet applications and environments.

The use of such biometric displays, however, is not limited to games or social environments, but has usefulness in graphically communicating information about the user to the user based upon information which is either input by a user or input from third party resources, such as a health care provider, a biometric monitor, an exercise monitor, a scheduling resource, or the like. Connecting users with healthcare information within Internet based systems requires adherence with the Government regulations of the U.S. Department of Health and Human services enforced through its' Office for Civil Rights known as the HIPAA Privacy Rules, which protect the privacy of individual's identifiable health information. The HIPAA Security Rule sets national standards for the security of electronic protected health information. The confidentiality provisions of the Patient Safety Rule protect identifiable information being used to analyze patient safety events and improve patient safety.

Securely delivered to users a virtual biometric display containing an anthropomorphic graphic representation of the user is particularly useful for communicating through a visual medium that adjusts real-time to data inputs. Health, nutrition, performance behavioral risk-factors, other biometric or user entered information such as family medical history or performance statistics, can be presented to a user in a dynamically responsive graphic interface. The improved comprehension and the direct relationship between biometric data input and graphical display output provides for particularly useful and commercially viable applications including, but not limited to, healthcare, sports performance, education, government, and corporate utilization.

When used in combination with a health and well-being plan, goal-setting utility, a progress to goal tracking utility, an activity scheduling utility, an activity tracking utility and continued updating of user information, a system may be created in which the biometric display is dynamically responsive to a wide array of data inputs and acts to encourage the user to engage in or continue to engage in behavior that maximizes the user's health and progress toward user-set health, exercise, injury recovery or management of an illness, performance based athletics, nutritional plan, pregnancy, or well-being objectives.

### SUMMARY

The present subject matter relates to techniques and equipment for delivering to a user a biometric display containing a graphic representation of the user that communicates health and fitness performance related information about the user. Linking the biometric display to physical characteristics of a user and health related information about the user may provide a single graphically interactive display of healthcare, physical fitness, sports performance, nutritional well-being, and/or behavioral information about the user. This visual display may allow the user to more easily comprehend and take effective control of the user's overall health and wellness. Toward this end, the instant disclosure provides a Biometric Display System (BDS) that consists of secure and networked visual display processes in which a wide range of health, nutrition, well-being, and physical fitness data are input through secure network-connected computational devices. The input data is formulaically processed and analyzed through secure computer network resources and is converted into a biometric display with associative health parameters, which is then delivered to the user.

In one general aspect, the instant application describes a method for delivering to a user a biometric display containing a graphic representation of the user that communicates health related information about the user. The method includes steps of receiving via a communication network information associated with physical characteristics of the user and health related information associated with the user and generating a biometric display of the user based on the received physical characteristics associated with the user. The biometric display represents a virtual persona of the user tailored toward the received physical characteristics associated with the user. The method also includes steps of generating health parameters based on the received health related information associated with the user and associating the health parameters with their respective body parts on the biometric display. The health parameters communicate to the user health related information regarding their respective body part on the biometric display. The method also includes a step of delivering to the user via the communication network the biometric display along with the associative health parameters.

The above general aspect may include one or more of the following features. Receiving information associated with the physical characteristics of the user may include receiving from the user and over the communication network information associated with gender, height, arm length, leg length, eye color, hair color, skin color, and/or weight of the user. The communication network may include an Internet. Receiving the health related information associated with the user may include receiving from a health database and over the communication network the health related information associated with the user. The method may further include a step of receiving fitness performance related information about the user. The health related information may be uploaded into the health database from a diagnostic laboratory, a health care provider, and/or a biometric monitor.

Receiving the health related information associated with the user may include receiving health related information from a monitoring device worn by the user. The monitoring device may be configured to track the user's activity and upload information concerning user's activity to a health database. Generating health parameters may include generating active code flags which are either click-activated, fly-over activated, or voice-activated using an input device. The active code flags may be color-coded on a red-orange-yellow-green paradigm with a red color indicating a high health risk status or a poor health status, an orange color indicating moderate health risk status, a yellow color indicating a low to moderate health risk status, and a green color indicating a low risk status or a good health status. The active code flags may include a white color reflecting no data is available for a particular risk factor.

The method may further include a step of generating a window, which provides detailed information about a particular active code flag selected by the user. The window may include a first field displaying health risk factor associated with the particular active code flag selected by the user, a second field providing information about the health risk factor displayed in the first field, and a third field providing recommendations to the user for behavior modification relative to the health risk factor displayed in the first field. The method may further include steps of: receiving recommendation information in response to the health information associated with the user and delivering the recommendation information along with the biometric display to the user. The recommendation information may recommend behavioral modification to the user to address a particular health risk factor. Receiving the recommendation information may include receiving the recommendation information from an athletic organization, a governmental agency, healthcare organization, or research institute.

In another general aspect, the instant application describes a computer software program which operates on one or more computer networks that host all aspects of both secure input and output architecture of the virtual environment. Remote computers access the web servers and permit users to interact with the virtual environment. The web servers define user entry points for user logon to the virtual environment and host databases of user health information. The computer networks provide services, hardware, software infrastructure and compiled software code that provides instruction sets to handle and route user generated requests to a) query or prompt the user to enter certain information, including, for example establishing behavioral, activity, physical or health goals, set schedules of activities, establish logon protocols, e.g., user identification and passwords, account information, input behavioral activity, physical or health information, authorize linking to user health information generated by third parties, identify friends in the virtual environment, etc., and to b) display color-coded flags associated with the biometric display that serve both as risk-status indicators and as fly-over prompts or click-prompts that permit the user to access a secondary level of more detailed information associated with the particular body part or function represented by the biometric display.

Implementations of the described techniques may include hardware, a method or process, or software for a mobile device on a computer-accessible medium. The details of one or more implementations are set forth in the accompanying drawings and the description below. Other features will be apparent from the description and drawings, and from the claims. The following more detailed description of the invention taken with the accompanying drawings set forth in detail certain illustrative aspects of the claimed subject matter. These aspects are indicative of but a few of the various ways in which the principles of the invention may be employed and the claimed subject matter is intended to include all such aspects and their equivalents.

Many advantages may be realized by employing the BDS in accordance with the instant application. The BDS in accordance with the instant application can separate assessments into interactive categories connected with a personalized biometric display. Gaming features and realistic user representation may enhance utilization. Seamless integration with third party data providers can automatically populate fields such as blood test values and heart rate data. The BDS can incorporate the right balance of information and can integrate the information with the biometric display, making it a seamless experience for the user to learn about their health while simultaneously identifying risk areas. This may lead to a more natural inclination to learn about health and may apply directly to the individual in a real-time interactive format. Furthermore, the BDS may consolidate and communicate vital statistics via color-coded icons on the biometric display and personalized dashboard and may quickly allow the user to identify both individual parameters and overall categories needing attention. This is a critical step in dealing with current health risks while preventing potential future risks. Benchmark values may be integrated with the personalized color-coded communication so that a user can easily see where the user stands with respect to healthy ranges. A color-coded health status meter presents the user with a general overview score of their well-being. The BDS inextricably links health to life goals and allows the user to naturally want to be healthy.

The BDS may guide the user to choose an ultimate dream as well as to set major goals in each of the BDS categories. The BDS may flag and guide the user to set goals related to improving any risk health parameters that the system has identified. Using research-backed goal-setting parameters, the BDS may guide the user to set tasks as a strategy to achieve major goals, while providing common pathways and social interaction opportunities selected by other individuals. The BDS may then provide timely feedback to remind the user if they are on track to achieving their goals. The user can access a visual, color-coded dashboard of their achieved, pending and past-due life goals and can share individual category goals via social networking portals, allowing for further motivation and encouragement. A snapshot view allows the user to see a photographic biographical overview of their major achieved life goals. The user may thus have a seamless experience with identifying health risks, finding different pathway options for improving, choosing a pathway and setting a goal, and then sharing goals with friends via social media. Other advantages and novel features of the claimed subject matter will become apparent from the following detailed description when considered in conjunction with the drawings.

### BRIEF DESCRIPTION OF THE DRAWINGS

FIG. 1 illustrates an exemplary Biometric Display System (BDS).

FIG. 2 illustrates an exemplary home page presented to the user upon user's login to the system shown in FIG. 1.

FIGS. 3-10 illustrate variations of the home page presented in FIG. 2 depending on the user's selection of a particular category within the home page.

FIG. 11 illustrates an exemplary web-page generated by a web server shown in FIG. 1, providing a health status summary report of a male user.

FIG. 12 illustrates an exemplary web-page generated by a web server shown in FIG. 1, providing a health status summary report of a female user.

FIG. 13 illustrates an alternative exemplary home page, which is presented to the user after successful login into the web server shown in FIG. 1.

FIG. 14 illustrates an exemplary schedule web-page activated from the scheduling section of the home page shown in FIG. 13.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

In accordance with the present disclosure, there is provided a Biometric Display System (BDS) that generates a biometric display of a user, referred to herein as a “biometric display.” The biometric display is a user customizable, interactive, humanoid character that displays or otherwise communicates, such as by audio or visual communication, a user's most recent health status using coded active points associated with the biometric display. Both the biometric display and the health information associated with the biometric display may be integrated with a secure mobile application to communicate a user's active health status on mobile computing devices, such as personal digital assistants, e.g., BLACKBERRY devices, IPHONE devices, IPAD devices or the like, mobile telephones, etc.

The BDS may be utilized for both an end user to track and communicate personal physical and mental health and human performance metrics as well as for an administrative client (e.g., employers, healthcare providers, schools, etc) to track aggregate health and human performance metrics of its member. The user may log into the BDS by interfacing with a website. The user may then be introduced to the BDS once logged in and may be guided through a series of health and performance assessment questions and data inputs that interact with the anthropomorphic representation the user chooses to represent him/her. Initial questions populate the biometric display with appropriate physical attributes such as, for example, eye, hair, and skin color, glasses, etc.

The BDS may separate assessments into interactive categories connected with the biometric display (e.g., an avatar). The categories may include personal information, goals, vital indicators, screenings, lifestyle behaviors, physical activity, nutrition, and measurements. The BDS may obtain user health information from the user. Alternatively or additionally, the user health information may be obtained through biometric monitors worn by the user, which can be associated with radio frequency identification devices (RFIDs), BLUETOOTH enabled devices, wireless and Internet based devices. Alternatively or additionally, approved third party healthcare resources such as insurance companies, pharmacies, diagnostic laboratories, doctor's offices, hospitals, etc. may provide the BDS with the user health information. The user health information may be stored in a health database. The health database may be accessed by the BDS for uploading user information, process such information and dynamically modify the biometric display, and over time, provide a most current set of information to the user through the biometric display.

Seamless integration with third party data providers can automatically populate fields such as blood test values and heart rate data. For example, a user can order an at-home blood test from one of the BDS partners, and the results are automatically populated within the BDS. For another example, a user can download heart rate data from a wristwatch monitor and the data is transferred to the BDS. The BDS consolidates and communicates vital statistics via color-coded icons on the biometric display and personalized dashboard and quickly allows the user to identify both individual parameters and overall categories needing attention. This is a critical step in dealing with current health risks while preventing potential future risks. Benchmark values may be integrated with the personalized color-coded communication so that a user can easily see where the user stands with respect to healthy ranges. A color-coded health status meter presents the user with a general overview score of their well-being.

To illustrate one specific example, the biometric display displays health risk status associated with various diseases affecting the user. For example, the biometric display displays health risk-factor information for heart disease, diabetes, kidney disease, liver disease, thyroid disorders, osteoporosis, prostate cancer, and/or colorectal disease. Specific health parameters which are displayed on the biometric display include, without limitation, overall health status, blood pressure, total cholesterol, HDL cholesterol, LDL cholesterol, triglycerides, blood sugar, A1c, bone density, heart rate, stress level, body mass index (BMI), height, weight, chest measurements, bicep measurement, calf measurements, quadriceps measurements, caloric consumption and caloric output (i.e., exercise). One skilled in the art recognizes that this list can be expanded to include additional parameters of categories if needed. Additionally, the biometric display flags the user for routine wellness screenings for, for example, skin cancer, colonoscopy, prostate exams, pap smears or prostate cancer.

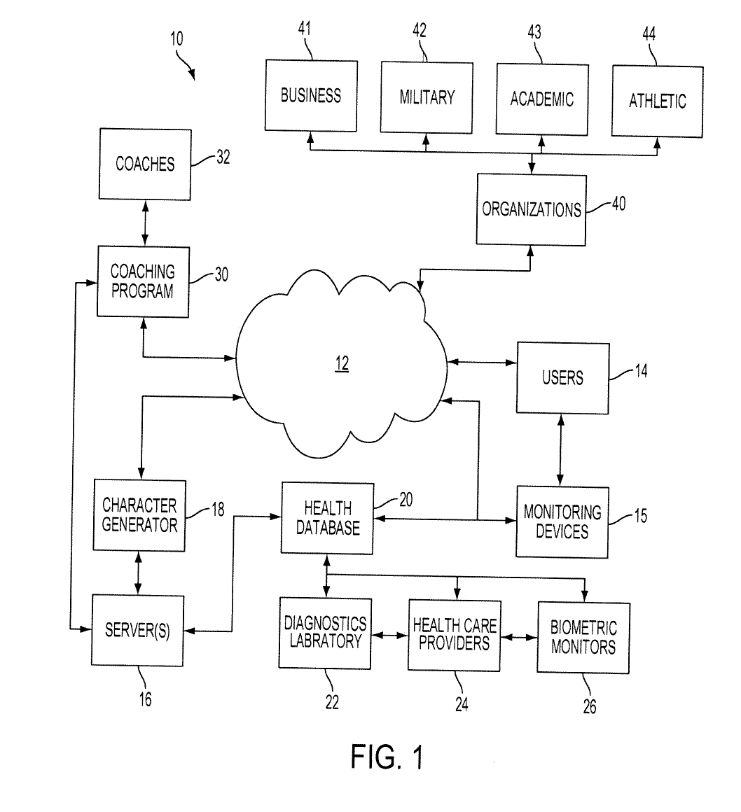

FIG. 1 illustrates an exemplary BDS 10. The BDS 10 includes at least one web server 16 publishing a website that is accessible over the network 12. At least one user 14 interfaces with the network 12 using a local computer and accesses the web server 16 over the network 12. Alternatively, the user may interface with the network 12 using a mobile device and access the web server 16 over the network 12. The web server 16 may define user entry point for user logon into the virtual environment and may provide access to a health database. The web server 16 includes a login page which solicits the user for username and password for access to the virtual environment. If the user is not a registered member of the site hosted by web server 16, the user can go to the user registration and provide registration information. The registration information may include, among others, first name, last name, e-mail address, gender, date of birth, username, and password. After completing the registration page, the user may select a payment option to pay for the services provided by the web server 16. The user can make payment using the user's credit card information. The web server 16 may pass the credit card information to an authentication server (not shown) for authentication. Upon successful authentication, the user may become registered. In a slightly different implementation, the services of the web server 16 may be provided to the user for free.

Upon successful registration, the user may log into the web server 16 by providing his/her username and password. The user may then be introduced to the system once logged in and may be guided through a series of health and performance assessment questions and data inputs that interact with the anthropomorphic representation the user chooses to represent him/her. Initial questions may be used to populate the biometric display with appropriate physical attributes specific to the user such as, for example, eye, hair, and skin color, glasses, etc.

The web server 16 may interact with a character generator 18 to upload a biometric display associated with the user. The character generator 18 is a program that links with the web server 16 and receives information from the user 14 and generates the biometric display of the user 14 based on the received information. The received information may include, without limitation, height, weight, diet, exercise completion statistics, family medical history, physical fitness test results, performance test data, blood test results, urine test results or hair test results, and/or image of the user. Other information about the user, such as health related information may be uploaded to the web server 16 via a health database 20.

The health database 20 may receive health information from third party sources such as, for example, a diagnostic laboratory 22, a health care provider 24, and/or a biometric monitor 26. Additionally, the user 14 may wear a monitoring device 15 (e.g., GPS, RFID) to track the user's activity and upload information concerning the user's activity either to the health database 20 or directly to the web server 16 via the network 12. The health related information may affect generation of the biometric display or the output of information concerning user 14 over the web server 16. In one specific example, the health related information is associated with various portions of the biometric display and together with the biometric display are displayed to the user 14 at the user's home page.

As will be discussed in more detail, the character generator 18 and the web server 16 periodically receive information concerning the user 14 as the information is uploaded by the user 14 and/or by third parties to the health database 20. Based upon such uploaded information, the character generator 18 and the web server 16 dynamically alter the biometric display and the information conveyed by the biometric display concerning the user's health risk factors and behavioral modification recommendations. The character generator 18 translates the input data into a multimedia display that includes, without limitation, a computer generated character, a digital device display, a digital 3D hologram, video (digital, HD, analog, streaming, or the like), computer readable code (FLASH, HTML, 5, JAVA, HTML, PHP, C, or the like), a mobile display device, an internet website display, a BLUETOOTH connected device display and/or a broadband connected device display. The inputs and outputs of the system may be managed by a secure computer network that is able to automate real-time adjustments to outputs based on user inputs including a battery of tests covering every aspect of well-being, nutrition, physical fitness, diet, mental and physical wellness.

The term “network” is intended to include any system that includes a series of points or nodes interconnected by communication paths. Networks can interconnect with other networks and contain subnetworks. Non-limiting examples of networks include wired networks, e.g., LAN or WAN, radio frequency networks, e.g., wireless networks, mobile communication networks, and computers connected through the Internet.

The BDS 10 may also include a coaching program 30 that serves as a portal for coaches 32 to interface with the user 14 to provide encouragement, recommendations, cautions or the like regarding the user's level of activity, health risks, behaviors, etc. The coaching program 30 may either be a module in the HTML code deployed on the web server 16 or may be a stand alone program resident on a separate server and called by the web server 16 under appropriate circumstances, such as login by a coach 32. A coach 32 is a role which may be created by an administrator in an offline mode. The coach may have nothing to do unless the administrator associates the coach to a specific community. In this scenario, if the coach is not associated with any specific community, the user may be presented with a proper alert message showing “you are not yet to be associated with any community, please contact administrator.”

Assuming the coaching program 30 is a module in the HTML code deployed on the web server 16, a coach 32 contacts the web server 16 to register as a coach. The web server 16 validates the details of the coach 32 and upon successful verification may send out a mail to the coach 32 with a registration code and a unique URL. The coach 32 selects the URL, which takes the coach 32 to the proper registration page. At the registration page, the coach 32 may provide the registration code and all other required data. Upon submission of the form the coach 32 may receive a successful registration message and then the coach 32 can login to the system from the web server 16.

The coach 32 may be able to login to the web server 16 through the regular user interface for other members. Upon authentication, the coach 32 may be taken to the coach version of the web portal which may include, among other sections, a health statistic section, a community section, information section, and a calendar section. The health statistic section may include the biometric display of the user and health related statistics associated with the user. The community section displays the communities associated with the coach 32. The information section displays general information about the coach 32. The calendar section includes events and exercise sessions called “functices” for the communities associated with the coach 32.

The coach 32 can create events, edit, and/or delete events and functices for the community. In this case, the coach 32 is associated with multiple communities, the coach may have the option to choose the community before he/she can create, edit, and/or delete the events and functices. The difference between an event and a functice is that an event needs to be associated with the training program whereas the functice is a single day team gathering. The system may not allow the user to create an event if the event conflicts with another event. The coach web portal may include an added field for allowing the coach 32 to add a URL for the event. This field is optional though. In case the URL is available, the URL is displayed against the event in the event listing page.

In addition to creating an event, a coach 32 may cancel an event or edit the date of an event. In both cases, the system may perform the following: (i) send out mail to all members of the community stating the cancelation of the event; (ii) delete the associated training plan, thus the training plan does not show up at the user's web portal after cancellation of the event; and (iii) retain all session feedbacks entered by the user against the canceled event's training plan. In addition to creating an event, a coach 32 may create a functice for a specific community. To this end, the coach 32 may choose one of the types of functice: close or open. The closed functice may only show up in the calendar of the community members. The open functice may show up to all.

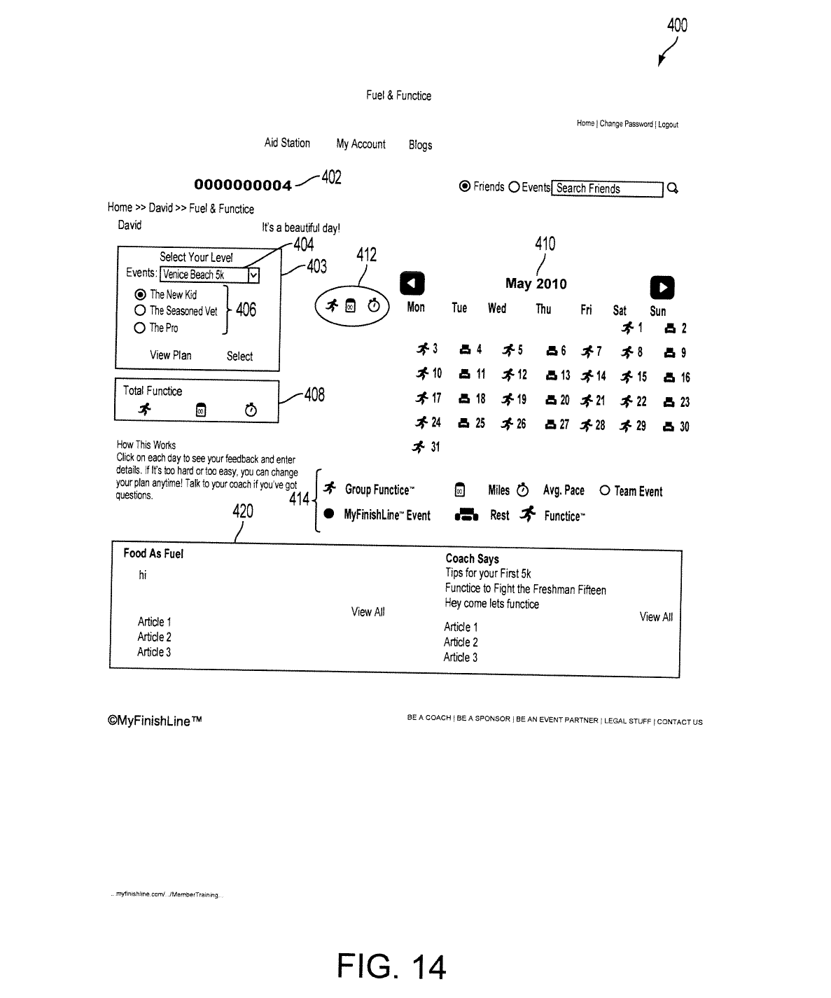

A coach 32 can also create a training plan against the event. To do so, the coach 32 may choose the community followed by the event against which the training plan is created. Then, the coach 32 may define a name, length in weeks, a level, and an activity for the training plan. The coach 32 may not be able to set a different length of training for different levels; however, the coach 32 may be able to set the activity differently for different levels. The system may not allow the coach 32 to create a training plan which might overlap any previously created training plan, instead the system may suggest the coach 32 for the best possible length that he can choose for the event selected. Once the plan is created, the coach 32 may publish the training plan. Once published the plan may not be deleted. The coach 32 may also be able to create/edit/delete articles in an article page of the coach's web portal. Upon publication of the articles, the same could be viewed by the community user. Details of the view of the article are covered in the “Fuel and Functice” section of the user described with respect to FIG. 14.

The organizations 40 may offer access to the BDS 10 as either a benefit or as a subscription-based service to employees, customers, members or clients to expand the number of users 14 of the BDS 10. The organization 40 may include, for example, businesses 41, such as employer groups, health insurance plans, fitness centers, weight loss centers or the like, military 42 or other governmental agencies, academic institutions 43, such as universities, high schools, junior high schools, elementary schools, or the like, or athletic organizations 44, such as park district teams, professional athletic teams, athletic recruiting organizations or the like.

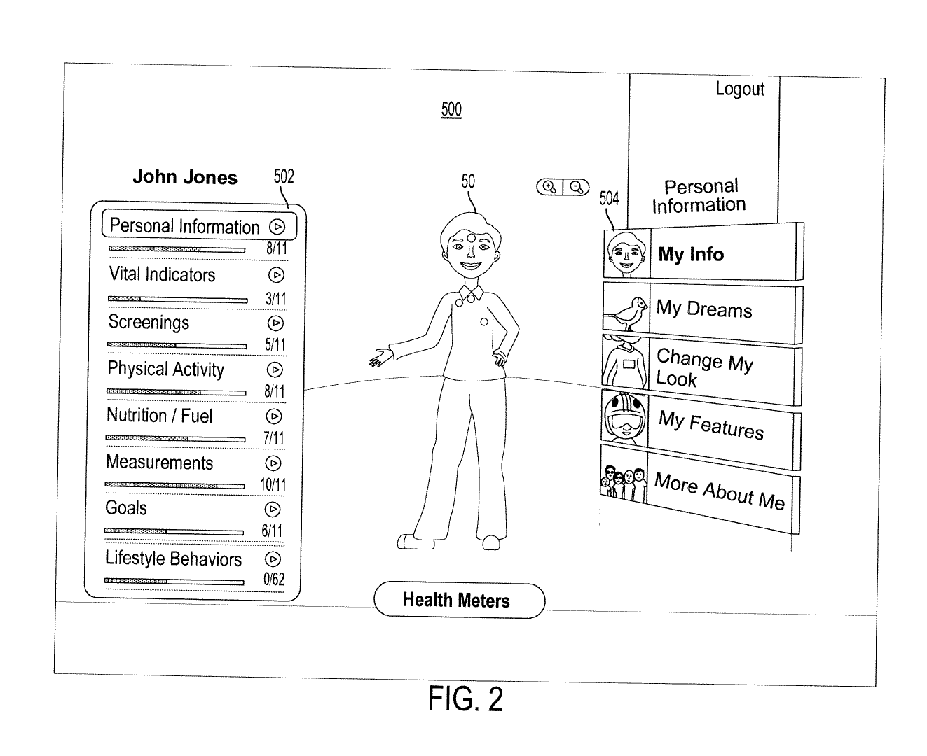

FIG. 2 illustrates an exemplary home page 500 presented to the user upon user's login to the web server 16. The home page 500 includes a biometric display 50, a category section 502, and a subcategory section 504. As shown, the biometric display 50 is personalized. The personalization may happen after the user completes the categories shown in category section 502. The category section 502 includes several categories such as, for example, “Personal Information,” “Vital Indicators,” “Screenings,” “Physical Activity,” “Nutrition/Fuel,” “Measurements,” “Goals,” and “Lifestyle Behavior.” Upon selecting the “Personal Information” category, the subcategory section 504 displays subcategories of the “Personal Information” category. As shown, the subcategories include “My Info,” “My Dreams,” “Change My Look,” “My Features,” and “More About Me.”

In the “My Info” subcategory, the user may enter data such as, for example, name, email address, mailing address, date of birth, blood type, gender, and/or ethnicity. Data such as blood type, gender, ethnicity may be utilized in the algorithm for overall health score and for communicating to the user specific health risk factors that pertain to their individual situation. The “My Dreams” subcategory may allow the user to either select or create an ultimate goal or dream. This dream may then be placed on each main webpage of the system, to remind the user of his/her dream. With “Change My Look” subcategory, the user is able to select a particular biometric display 50 (e.g., an avatar) that most closely represents the user. The biometric display 50 may be based on the user's digital photograph uploaded into the system. The user may be able to specify clothing for the biometric display 50. Although the anthropomorphic representation of the user in this case is an avatar of a sort, other representation may be provided to cover all aspects of anthropomorphic representation, such as a holographic image displayed in any setting. With “My Features,” the user answers questions related to the user's physical features, which then populate the biometric display 50 in real-time. The answers may be saved in the algorithm that later communicates health risks to the user. For example, hair color, skin tone and eye color are a significant data set that predicts skin cancer risk and frequency of screenings. In the “More About Me” subcategory, the user may enter basic data such as whether or not the user is a student, highest level of education and other data that could be utilized by the system to generate a health risk status and score.

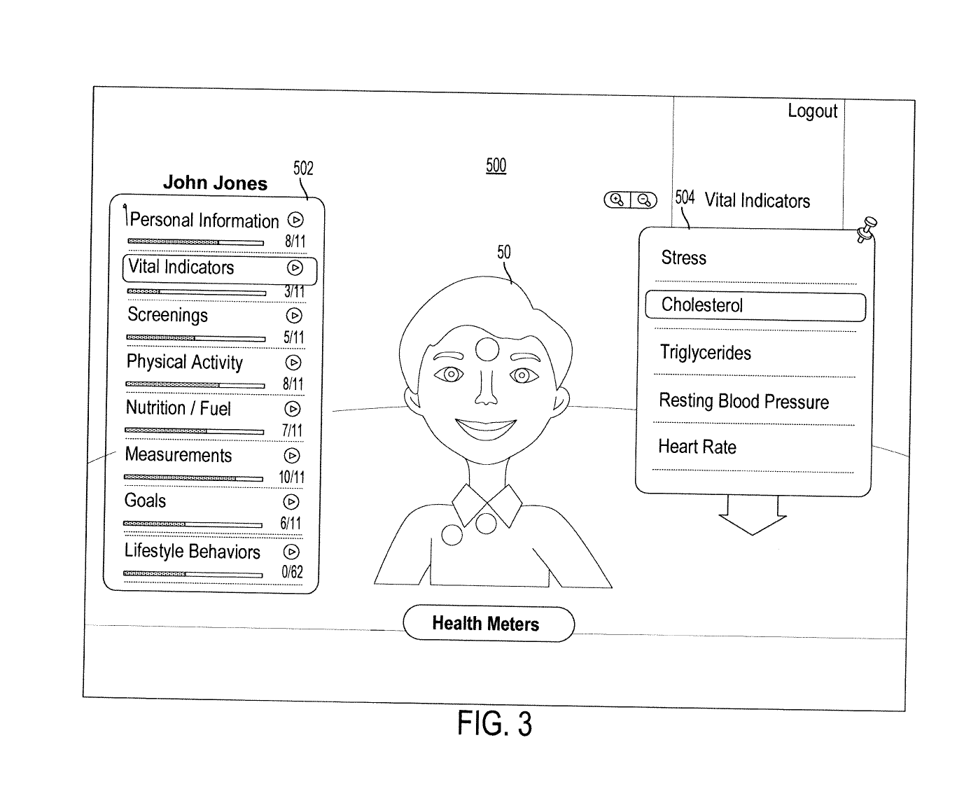

Upon user selection of the “Vital Indicator” category in the category section 502, the subcategory section 504 displays the subcategories of the “Vital Indicator” category, as shown in FIG. 3. The subcategories of the “Vital Indicator” category include “Stress,” “Cholesterol,” “Triglycerides,” “Resting Blood Pressure,” and “Heart Rate.” The system may also provide a snapshot view of user's overall scores associated with each of the subcategories in this category. This category may display a color-coded score based on user's health risk status of all their vital indicators, including parameters such as, for example, cholesterol, triglycerides, blood glucose, blood pressure, etc. The icons on the biometric display 50 may also display the values and color codes for a more quick and comprehensive view of health status. The user can scroll over each icon on the biometric display 50 to find more information related to an individual parameter.

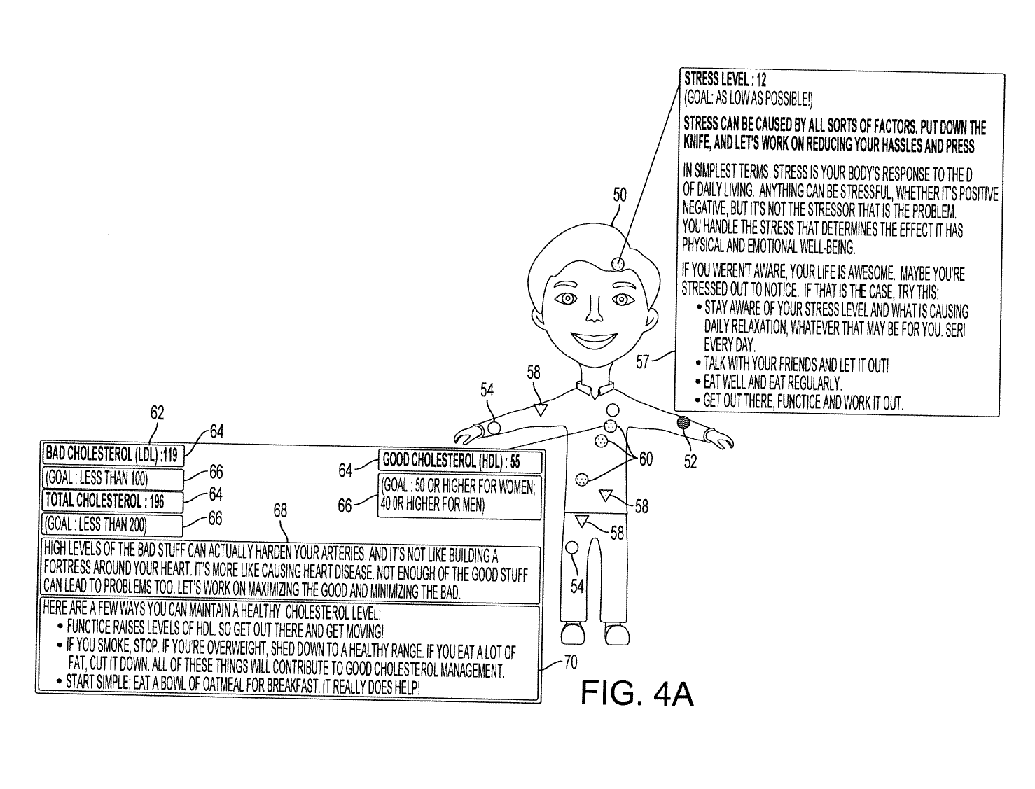

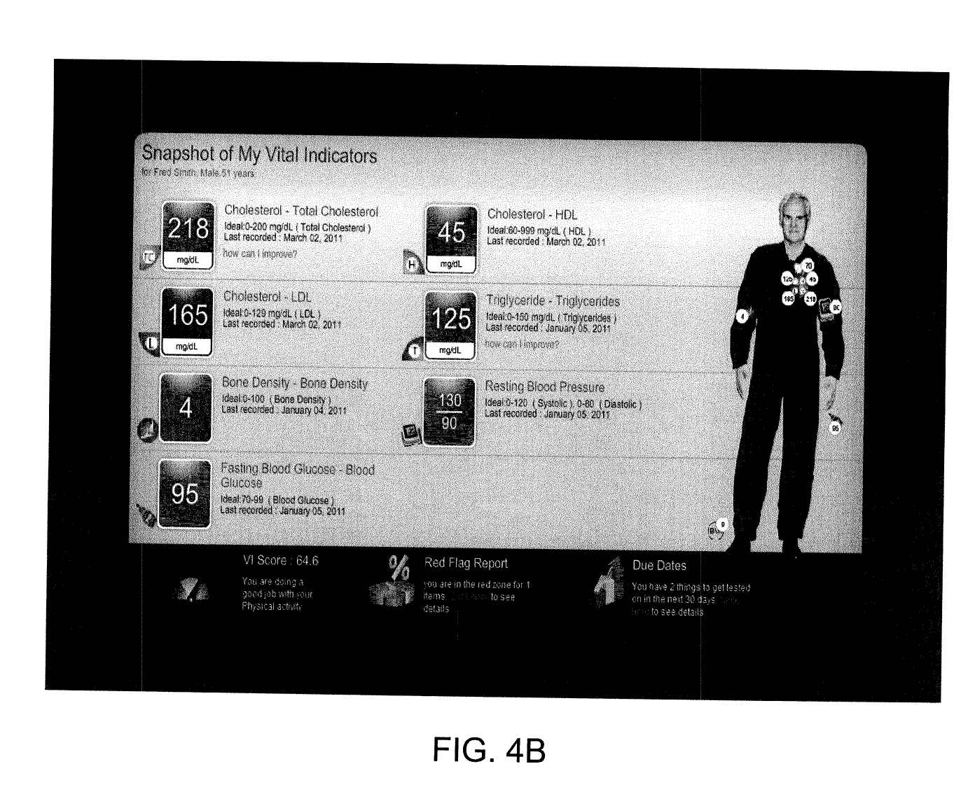

FIG. 4A illustrates an exemplary biometric display 50 including associative active code flags 52, 54, 56, 58, and 60 that are either click-activated or fly-over activated using an input device (e.g., a mouse). The active code flags 52, 54, 56, 58, and 60 may include an indicia, which may be a geometric shape (e.g., a square, circle, triangle, diamond, star, etc), a color (e.g., red, green, yellow, white, gray, etc.), and/or an associated sound or other visual or auditory indicator of the status of the active code flag. In one implementation, the active code flags are color-coded on a red-orange-yellow-green paradigm, with a red color indicating a high health risk status, an orange color indicating a moderate health risk status, a yellow color indicating a low to moderate risk, and a green color indicating good health. A white color is indicative that no data is available for that particular risk factor.

As depicted in FIG. 4A, a first active code flag 52 is positionally associated with the character's forearm and relates to a blood glucose/A1c risk factor. The first active code flag 52 may be a green circle indicating a low risk factor. The second active code flag 54 is also positionally associated with the character's forearm and relates to the user's blood pressure. The second active code flag 54 may be a white circle, indicating no blood pressure data has been uploaded to the health database 20. The third active code flag 56 is positionally associated with the character's head and relates to the user's stress level. The third active code flag 56 may be a yellow circle, indicating low to moderate risk. The fourth active code flags 58 are positioned on the character's groin region, abdominal region, and upper arm region and are indicative of prostate exam, colonoscopy and skin examination risk factors, respectively. The fourth active code flags 58 may be grey triangles, reflecting that only recommendation data is available. The fifth active code flags 60 are positioned on the character's heart, thoracic, and lower right abdominal regions and represent cholesterol data, triglyceride data, and body mass index data, respectively. The fifth active code flags 60 may be green circles, indicating low risk factor. It will be understood by those of ordinary skill in the art that the foregoing description is exemplary in nature and that the specific health risk factors, active code flag selection, positioning on the character and the like may be varied.

Once activated, an active code flag will generate a secondary window 62 with further more detailed information on the particular health risk factor selected by the user 14. As depicted in FIG. 4A, activating active code flag 60 over the character's heart generates a secondary window 62 describing the user's cholesterol information. Within the secondary window 62, a first field 64 displays health risk categories, in this case “Bad Cholesterol (LDL),” “Good Cholesterol (HDL),” and “Total Cholesterol” together with their current values. A goal field 66 is provided that indicates target or normal values for each of the first field 64 categories and is, preferably, positioned proximate or adjacent the first field 64. A second field 68 is provided in secondary window 62 and conveys information pertaining to the risk factor displayed in the first field 64. A third field 70 is provided in the secondary window 62, which provides recommendations to the user 14 for behavior modification relative to the health risk factor category in the first field 64.

The vital information may be manually entered. Alternatively or additionally, the vital information may be seamlessly provided by an outside device or product/system such as an at-home blood test kit that is sent back to a lab, in which the lab's system auto-populates the system. Although not shown, the system may also show a VI score for the category. Additionally, the system may allow access to the red flag report, which provides a summary of red flag items within the category and overall red flags. The system may also inform the user of due dates, reflecting any upcoming or outstanding dates associated with important screenings, appointments, areas in the system needing attention, etc. In each category, the user may be presented with the biometric display view as shown in FIG. 4A. Alternatively or additionally, the user may be presented with a snapshot view as shown in FIG. 4B.

FIG. 4B illustrates an exemplary snapshot view providing user with an overview of the user's vital scores. The snapshot view may display a color-coded score based on user's health risk status of all the user's vital indicators, including parameters such as cholesterol, triglycerides, blood glucose, blood Pressure, etc. As shown, the boxes contain the value of the parameter, for example 218 for total cholesterol. Also, color may be associated with this value, as a risk factor, where red is highest risk, then orange, yellow, and green is lowest risk. The icons on the biometric display 50 may also display the values and color codes for a more quick and comprehensive view of health status. Similar to FIG. 4A, the user can scroll over each icon on the biometric display 50 to find more info related to an individual parameter. The bottom panel shows the VI score for the category. Also allows access to the Red Flag Report, which provides a summary of all Red Flag items within the category and Overall Red Flags. Due Dates reflect any upcoming or outstanding dates associated with important screenings, appointments, areas in the system needing attention, etc.

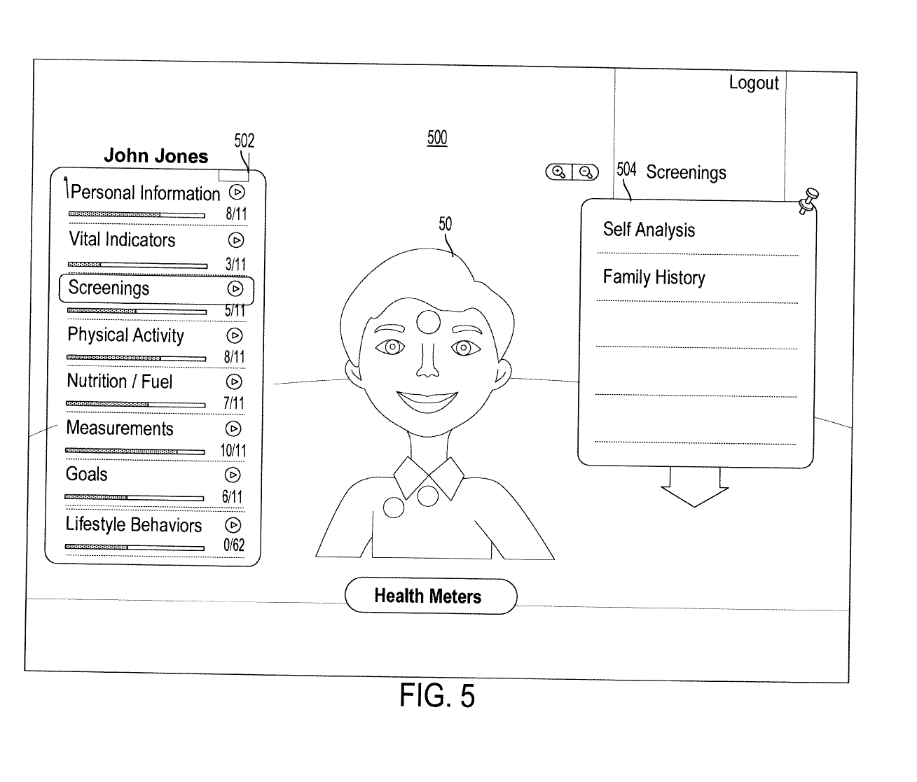

Upon user selection of the “Screenings” category in the category section 502, the subcategory section 504 displays the subcategories of the “Screenings” category, as shown in FIG. 5. The “Screenings” category may enable tracking and monitoring of current health risks and preventing potential future risk factors. The system may incorporate the right balance of information and may integrate it with the biometric display 50, making it a seamless experience for the user to learn about their health while simultaneously identifying risk areas. This leads to a more natural inclination to learn about health and applies directly to the individual in a real-time interactive format. The “Screenings” category includes “Self Analysis” and “Family History” subcategories. The “Family History” includes family history data and risk factor (e.g., allergy, asthma, back pain, heart disease, heart attack, diabetes, etc.). The “Self Analysis” subcategory includes self-reported history data and risk factor (e.g., allergies, asthma, back pain, breast cancer, etc.).

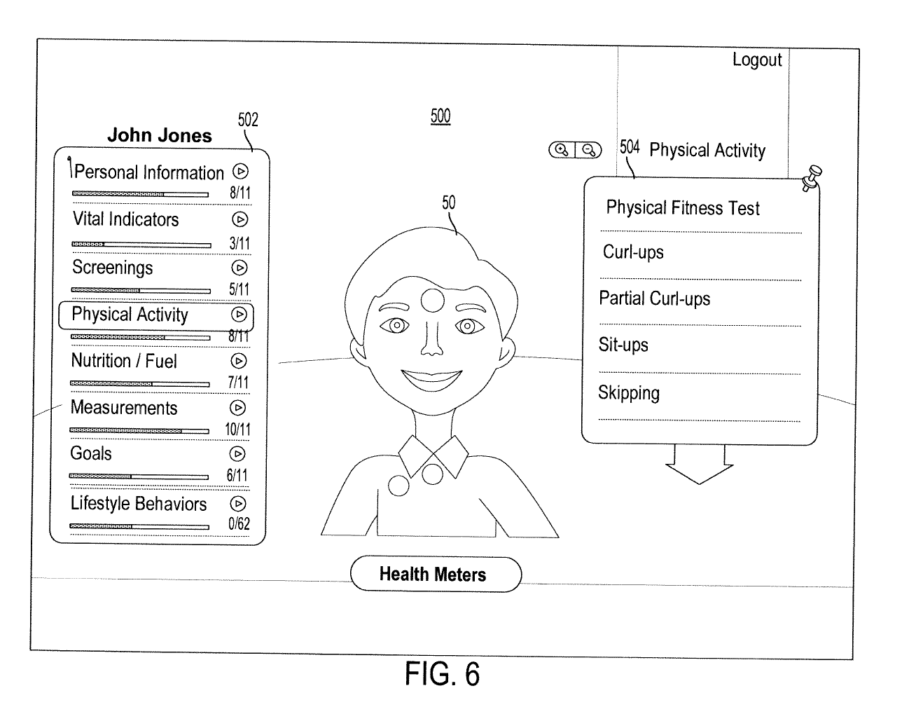

Upon user selection of the “Physical Activity” category in the category section 502, the subcategory section 504 displays the subcategories of the “Physical Activity” category, as shown in FIG. 6. This category may track and communicate information related to physical activity. It includes a fitness test as well as tracking individual activity parameters such as sit-ups, curl-ups, heart rate data and other data points associated with a physical activity. This category may also track activity data related to frequency of exercise, total time of exercise each day, and/or intensity of exercise. Most categories, like this one, may provide a color-coded score for the entire category, as well as individual parameters. Next to each parameter on the right although not shown, there may be a score and a color-coded bar, representing the color-coded range for that individual parameter. For example, partial curl-ups may be green with a score of 95. The user can take a fitness test and compare values to benchmarks. For example, a color-coded bar may be used to indicate where the user falls within a poor to excellent range in comparison to a benchmark and a national average. Comparisons can also include smaller populations, such as comparisons with other schools, cities, districts or classes. The system may allow the user to view the graphic representation of the user's physical fitness data over time.

The “Physical Activity” category may also provide a heart rate meter. The heart rate meter may collect and display heart rate data based on manual input or uploaded data from a compatible device such as a wristwatch monitor. The heart rate data may include maximum heart rate (e.g., 220—user's age), date, activity name (e.g., running), intensity (e.g., light, moderate, high), perceived exertion (e.g., low to high), time per day (e.g., hours and min), steps, target heart rate zone, and/or average heart rate zone. Information buttons or instruction text may allow user to find out more detail on each of the above-listed data. The system may show status of the user as it compares to national recommendations. For example, the system may show the user's data in terms of frequency, intensity, and time as it relates to adult or child recommendations for the physical activity.

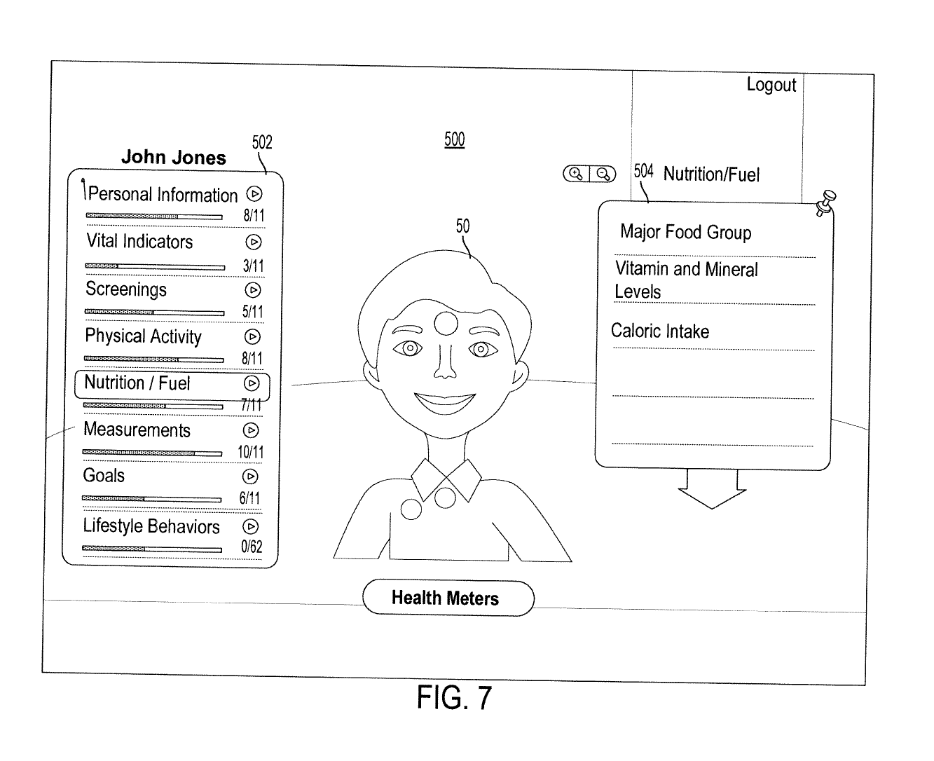

Upon user selection of the “Nutrition/Fuel” category in the category section 502, the subcategory section 504 displays the subcategories of the “Nutrition/Fuel” category, as shown in FIG. 7. This category may be used to capture and monitor nutrition metrics. To this end, this category may provide nutrition score based on user answers to specific questions relating to nutrition. The user may interact with the biometric display 50 by scrolling over data points on the biometric display 50 to view various nutritional levels associated with the user. Subcategories of this category include the major food groups, blood vitamin and mineral levels, and caloric intake over time. The system may display a visual meter to the user, which may be used to track hydration, such as amount of water consumed each day or sugar each day, percentages of carbohydrates, proteins, and fats being consumed. Similar to other categories, the user can access data points by scrolling over the icon on the biometric display 50 or by selecting parameters in the subcategory section 504. This was, for example, shown with respect to FIG. 4A and is not described here in more detail for the sake of brevity.

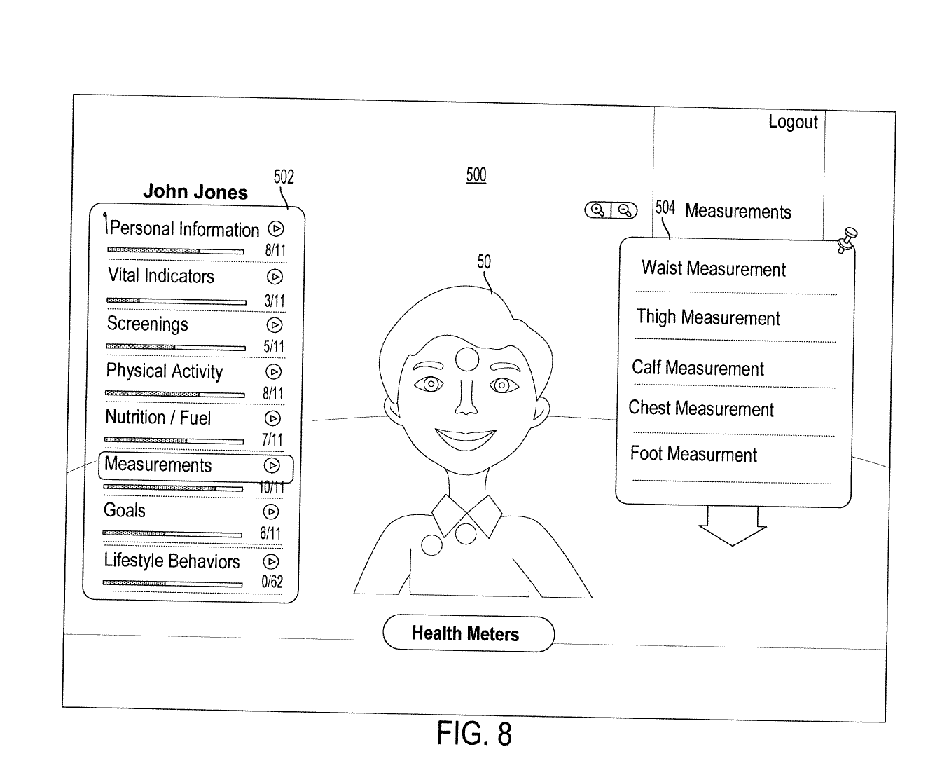

Upon user selection of the “Measurement” category in the category section 502, the subcategory section 504 displays the subcategories of the “Measurement” category, as shown in FIG. 8. This category may be used to capture, monitor, and display related to physical measurements. The physical measurements include waist, thigh, calf, chest, foot, neck, bicep, head, hips, height, weight, leg length, arm length, wrist, elbow, body frame size, etc. Similar to other categories, the system may inform user (e.g., via email, text, mobile or other device) based on data that falls outside a specific healthy range. Similar to other categories, the user may access data points by scrolling over the icon on the biometric display 50 or by selecting parameters in the subcategory section 504. This was, for example, shown with respect to FIG. 4A and is not described here in more detail for the sake of brevity. The information for this category can be self-entered or seamlessly integrated by compatible device.

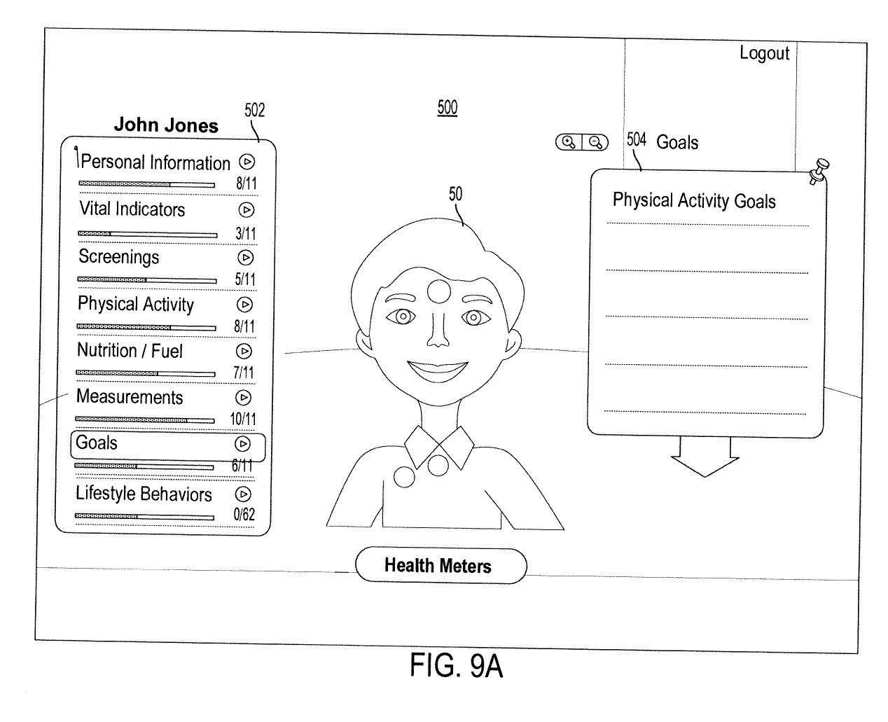

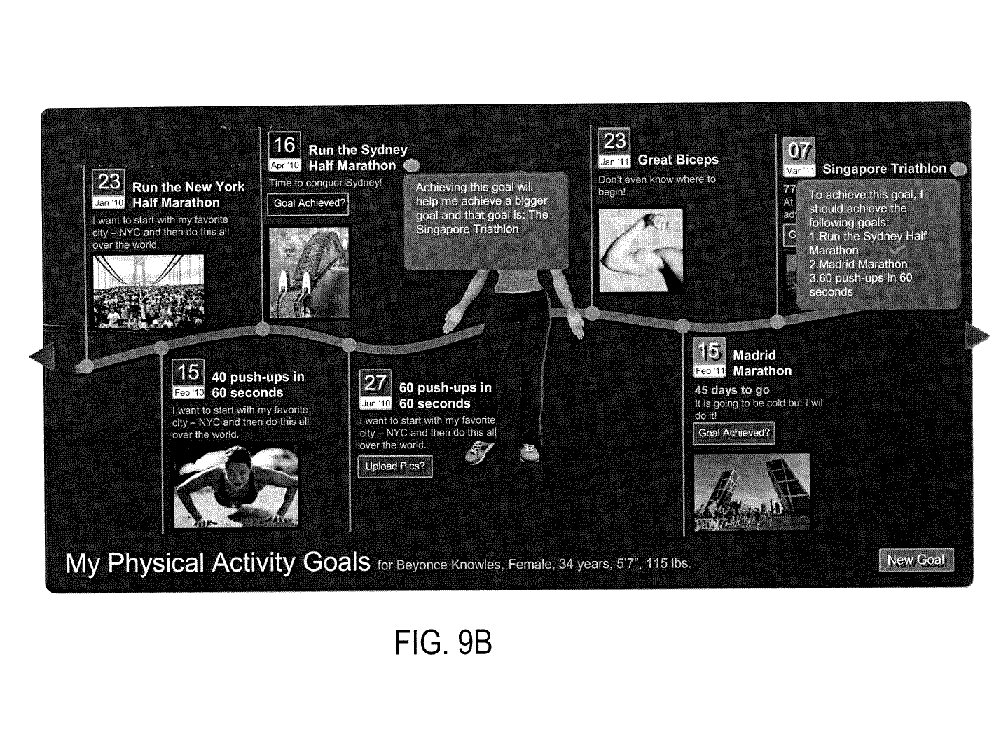

Upon user selection of the “Goals” category in the category section 502, the subcategory section 504 displays the subcategories of the “Goals” category, as shown in FIG. 9A. Using this category, the user can set and track goals and upload images associated with each goal, as well as connect them with larger dreams/goals the user may have. The user can also share goals with a social network and get feedback. The system may color-code the goals based on if the user has achieved them (green), missed the deadline (red), or has an upcoming goal (gray). The system may suggest to the user to set a goal if they are in a high risk factor (for cholesterol as an example). The system may also suggest different goals and pathways, such as suggesting local fitness groups, events, or even social networking sites to help the user achieve the specific goal. Using research-backed goal-setting parameters, the system may guide the user to set tasks as a strategy to achieve major goals, while providing common pathways and social interaction opportunities selected by other individuals. The user can then choose to either set a health goal relating to lowering cholesterol levels or not.

If the user chooses to set a goal, the system may request the user to choose a date to achieve it by and may ask if the user considers it as a major achievement and if it is part of a larger goal or dream. In this manner, the user can categorize different goals and track them over time. The system communicates to the user at specific intervals to make sure the user is progressing toward the set goal. The user may choose how to be reminded and communicated to (e.g., SMS, email, etc). The user can share the user's goals via social networking. The user can access a visual, color-coded dashboard of the user's achieved, pending and past-due life goals and can share individual category goals via social networking portals, allowing for further motivation and encouragement. The system may allow the user to see a photographic biographical overview of the user's major achieved life goals.

FIG. 9B illustrates an exemplary overview of the user's life goals. As shown, the user has previously set a goal of running a half marathon starting from New York city followed by other cities across the world. To achieve this goal, in addition to running the half marathon in New York city, the user may define the following sub goals: (1) running the Sydney half marathon, (2) Madrid marathon, and (3) 60 push-ups in 60 seconds. The user may also associate a particular date for completing a goal. For example, the user may decide to complete the New York city half marathon by Jun. 23, 2010, Sydney half marathon by Apr. 16, 2010, the 60 push-ups in 60 seconds by Jun. 27, 2010, and the Madrid marathon by Feb. 15, 2011. The system displays these goals in the user-specified timeline and solicits the user for information regarding the achievement of a particular goal and uploading of an achievement picture. The user may also inform the system that an achievement of a particular goal may help the user to achieve a bigger goal. For example, the user may inform the system that completing the Sydney half marathon will help the user to achieve a bigger goal of Singapore triathlon. In this manner, the system inextricably links health to life goals and allow the user to naturally want to be healthy. This category may interact with the overall system. The user can set goals from within a specific parameter in the system, rather than going directly to the “Goals” category. The system may direct the user from a parameter to goal setting, if the user selects to set a goal.

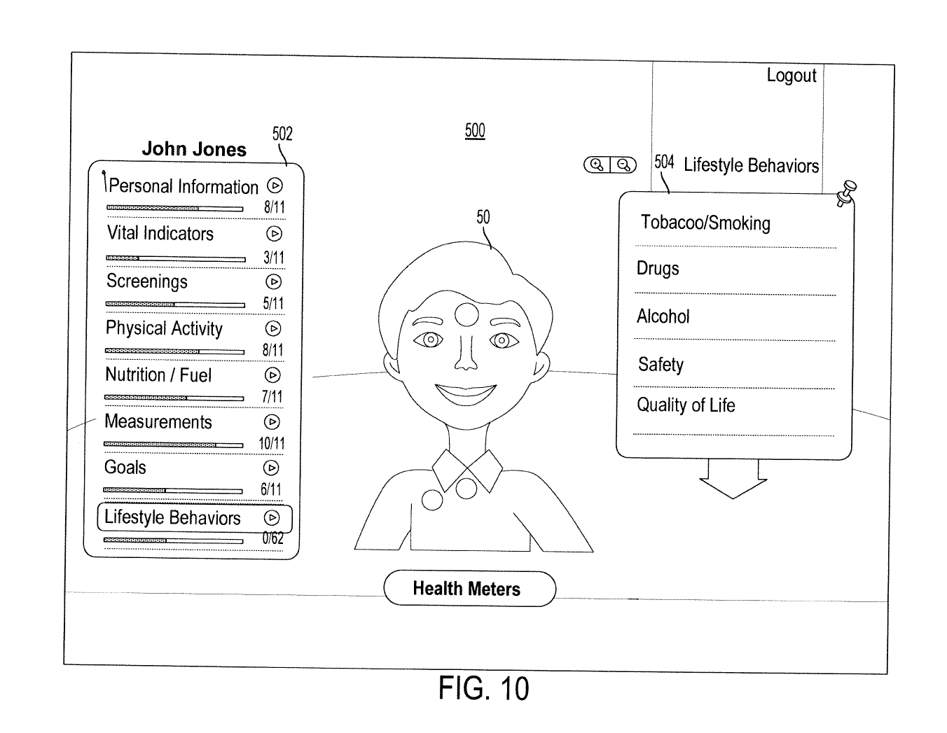

Upon user selection of the “Lifestyle Behaviors” category in the category section 502, the subcategory section 504 displays the subcategories of the “Lifestyle Behaviors” category, as shown in FIG. 10. This category allows the system to identify current unhealthy lifestyle behaviors, set goals for the user to modify them, and prevent future risks.

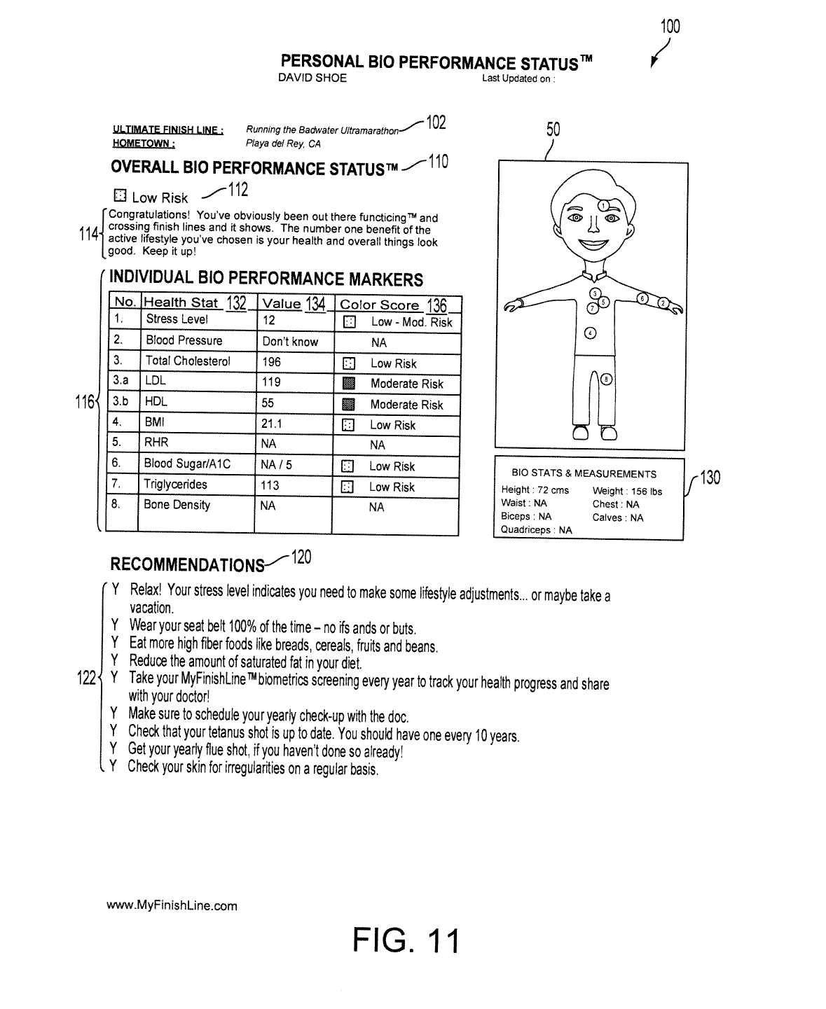

FIG. 11 illustrates an exemplary web-page 100 generated by the web server 16, providing a health status summary report of a male user. The web-page 100 is divided into five general sections 50, 102, 110, 120, and 130. The first section 50 includes the biometric display of the male user. The second section 102 includes a goal of the user, which may have been previously entered. The third section 110 includes an overall bio performance status of the male user. The fourth section 120 includes a recommendations section. The fifth section 130 includes a statistics and measurements section. The third section 110 may provide in graphical, narrative, and/or tabular form one or more of an overall health risk assessment indicator 112, an encouraging statement 114, and an individual bio performance markers 116, which may be presented in a tabular and graphical form, to convey a particular health statistic 132, a corresponding value 134, and a score 136, each of which is coordinated to a marker on the biometric display 50 to represent a particular health risk factor. The score 136 may be color-coded. The fourth section 120 provides at least one specific recommendation 122 to the male user for behavioral modification recommended to advance the user toward the user's goal specified in the second section 102. The fifth section 130 displays various user statistics and measurements, such as height, weight, physical measurements, such as waist size, chest size, limb sizes, etc. Some of these sections (e.g., third and fourth sections 110, 120) instead of being provided in a visual format may be provided in an audio format.

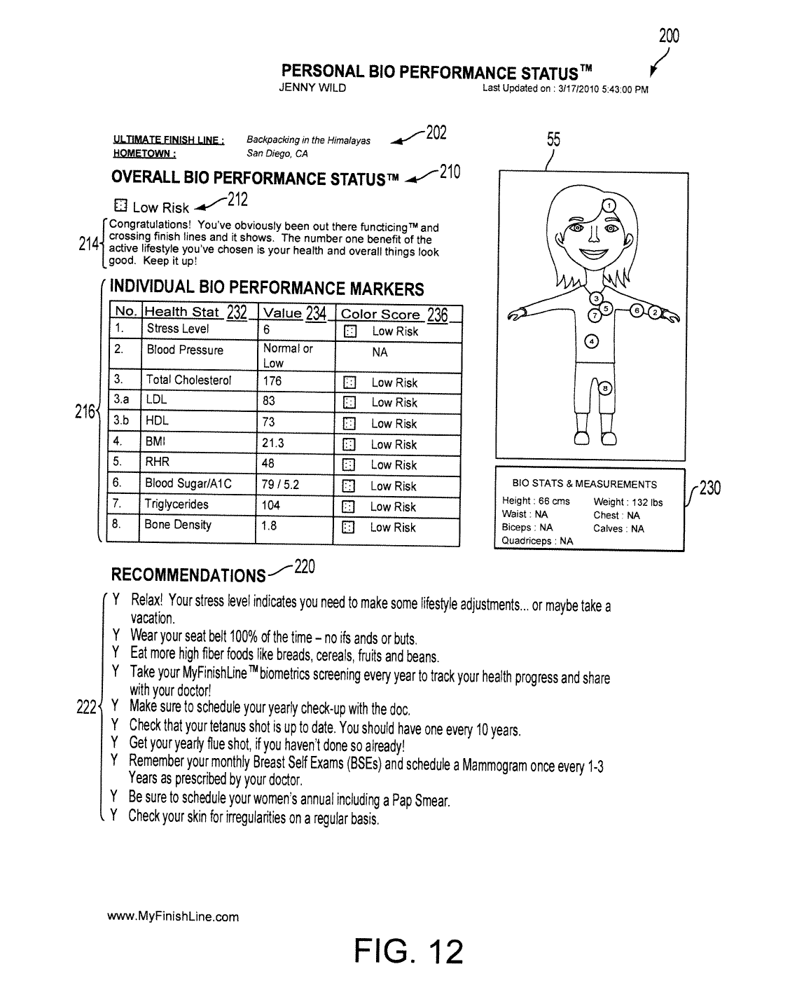

FIG. 12 illustrates an exemplary web-page 200 generated by the web server 16, providing a health status summary report of a female user. Like the web-page 100 associated with the male user, the web-page 200 associated with the female user includes five general sections 55, 202, 210, 220, and 230. The first section 55 includes the biometric display of the female user. The second section 202 includes a goal of the user, which may have been previously entered. The third section 210 includes an overall bio performance status of the female user. The fourth section 220 includes a recommendations section. The fifth section 230 includes statistics and measurements section. The third section 210 may provide in graphical, narrative, and/or tabular form one or more of an overall health risk assessment indicator 112, an encouraging statement 114, and an individual bio performance markers 116, which may be presented in a tabular and graphical form, to convey a particular health statistic 132, a corresponding value 134, and a score 136, each of which is coordinated to a marker on the biometric display shown in the first section 55 to represent a particular health risk factor. The score 136 may be color-coded. The fourth section 220 provides at least one specific recommendation 222 to the female user for behavioral modification recommended to advance the user toward the user's goal shown in the second section 202. The fifth section 230 displays various user statistics and measurements, such as height, weight, physical measurements, such as waist size, chest size, limb sizes, etc.

The web-page 200 associated with the female user differs from the web-page 100 associated with the male user in that the web-page 200 displays risk factors and recommendations 222 specific for female users, e.g., pap smears, mammograms, bone density measurements, etc., whereas the web-page 100 displays risk factors and recommendations specific for male users, e.g., prostate examination.

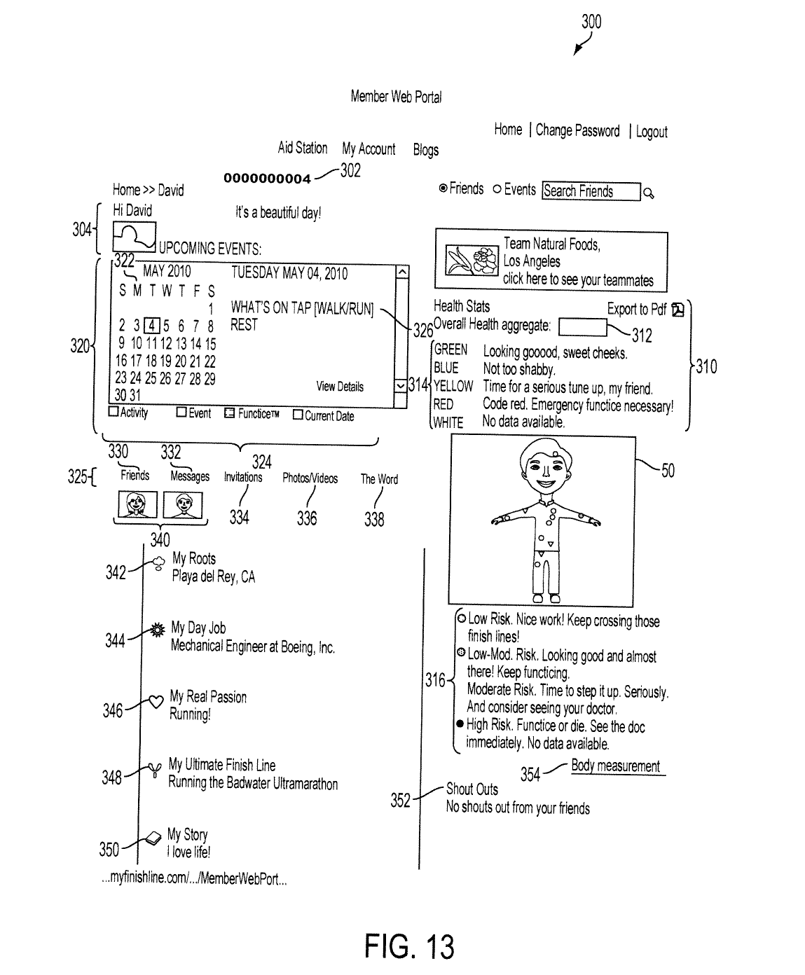

FIG. 13 illustrates an alternative home page 300 which may be presented to the user after successful login into the server 16. The home page 300 may be a single point of entry to multiple pieces of information regarding the user. In accordance with the exemplary embodiment depicted in FIG. 13, the home page 300 includes a sequential counter 302, a greeting field 304, a health statistics section 310, a biometric display 50, a scheduling section 320, and a social networking environment section 325. The sequential counter 302 may represent a number of activities the user has participated in. The greeting field 304 includes a photograph or other graphic uploaded by the user and is used for greeting the user.

The health statistics section 310 includes an overall health aggregate indicator 312 and keys 314. The health aggregate indicator 312 may be color-coded according to the above-described coloring paradigm or other graphic representation or indicator of the user's overall health state. The keys 314 are used for interpreting the health aggregate indicator 312. As shown, green indicator reflects the user is “looking good;” blue indicator reflects the user is “not too shabby;” the yellow indicator reflects “time for a serious tune up;” red indicator reflects “code red;” and white indicator reflects “no data available.”

The biometric display 50 is displayed in the home page 300 together with the active code flags 52, 54, 56, 58, and 60 associated with the biometric display 50. The active code flags 52, 54, 56, 58, and 60 were described with respect to FIG. 4A and are not described here for the sake of brevity. The active code flags 52, 54, 56, 58, and 60 may be associated with keys 316, which may be used for communicating the risk associated with the health related factor represented by the active code flags. In addition to being used to interpret their respective codes, the keys 314, 316 may provide encouragements to the user appropriate for the particular coded item. Hyperlinks to other physical information may be included in the home page 300, such as link 354 which opens a “body measurement” web-page.

The scheduling section 320 includes a calendar 322 and coded flags 324. The calendar 322 displays various previously scheduled activity of the user during the current month (e.g., May). For example, the calendar 322 displays current day user activity 326 regarding walk/run. The coded flags 324 are provided in association with the calendar 322 to indicate a particular event or activity associated with particular dates on the calendar. The coded flags 324 may be color-coded or may have such other type of indicator as desired to permit the user to differentiate between the events or activities on the calendar. As shown, the coded flags 324 relate to “Team Event,” “MyFinishLine™ Event,” “Functice™,” and “Current Date.” The date, month and year are selectable by the user to schedule, select and display events or activities associated with particular dates on the calendar 322 either prospectively or retrospectively.

The social networking environment section 325 is also provided on the home page 300. The social networking environment section 325 provides links to friends 330, messages 332, invitations 334, pictures or videos 336, and narrative pieces 338. Selection of a specific link 330, 332, 334, 336, and/or 388 displays the appropriate content associated with the selected link. For example, selection of the link to friends 330 results in displaying pictures 340 of the user's friends.

Other user specific information may be provided on the home page 300, including, historical information 342, work information 344, personal interests 346, goals 348 or other personal information 350 that the user wishes to share. Additionally, the home page 300 may include a communication link 352, which may be, for example, a bulletin board-type of link or an instant messaging type of link, and permits communication with other users of the BDS 10. In FIG. 13, the communication link is labeled as shout outs. Shout outs are like scrap book entries against the user's profile and may be created by the user's friends.

FIG. 14 illustrates an exemplary schedule web-page 400 activated from the scheduling section 320 of the home page 300. The user 14 can view details of his training plan, events and functices from the web-page 400. The web-page 400 can be reached by the user 14 upon selecting the “View Details” icon from the calendar at the home page 300. The web-page 400 includes an identifier 402 identifying the number of activities/training plans (e.g., four) available to the user. The training plans as created by the coach 32 for the community show up in the web-page 400 in section 403 based on the choice made out of three following levels 406: the New Kid, the Seasoned Vet, and the Pro. The web-page 400 allows the user 14 to view details of training plan, functice, and events by selection of the “View Plan” icon in section 403. The user 14 selects from a selection list 404 the type of activity the user 14 wishes to participate in based on the selected level 406. The selection list 404 may be a drop-down menu. In the illustrated example, the user selects the Venice Beach activity 5 k.

The calendar 410 is interactive in nature and enables the user to enter session feedback by clicking on the cells displaying the activity icon. The session feedbacks are feedback/comments of the user with respect to a particular accomplished activity on a particular date. The days which have been already filled may be color-coded in the calendar 410. The following questions may be presented to the user as a part of the feedback session: “how did you feel, function type, total running time, total running distance, what is your weight, your comments.”

Once the training plan is selected, the user may interface with a coach 32 through the coaching program 30 to prepare for the selected activity. Activities, distance, and pacing information are represented by icons in sections 408, 412, and 414 and appropriate icons are displayed on calendar 410 to permit the user 14 to view and follow an overall schedule which helps the user 14 to progress toward his/her established goal. The section 408 may represent a running counter, showing a total for each icon in the calendar 410. The section 408 may also indicate to the user whether an event is a group workout (e.g., functice), how many miles the user completed, and average pace of the user during the workout. The section 412 may take the user to a historical graph function showing totals over time for the user. The section 414 illustrates various legends describing the icons in the calendar 410.

A coaching section 420 may be linked to the coaching program 30 and may communicate information pertaining to dietary requirements and instructional coaching to the user 14 to assist the user 14 in progressing toward his/her goal. The coaching section 420 may display the latest three articles posted by the coach 32. A “view all” button will allow the user to view all the articles posted by the coach 32 in a separate page. The coaching section 420 may also display the latest three articles posted by a nutrition expert. A “view all” button will allow the user to view all the articles in a separate page named, for example, a “Food as Fuel” page.

Performance-related biometric data may be obtained from a number of standard testing protocols. Table 1, below, is illustrative of some of these testing protocols. The BDS may use the results of these testing protocols to animate objects such as human beings, animals, and plants in accordance with the present teachings. Inputs of physical data may be obtained from physical assessments or medical or diagnostic devices, including, without limitation, biopsy, body scan, ultrasound or blood, urine, feces, hair sample, fingerprint that results in biometric monitoring or biometric data.

The screening/test results may come from the assessment questions generated by the BDS itself. Alternatively or additionally, the screening/test results may come from an outside third party test or a device. In either case, the BDS may collect test results from physical, mental, and/or fitness tests/screenings and communicate them to the user in a color-coded risk-status alert format that may be displayed along with the biometric display 50 of the user.

TABLE 1
Function/Exam/Test

DNA diagnostics
Fingerprint records
Hearing Test Scores
Vision Test Scores
Postural Exam
Height
Weight
Menstrual Cycle
Dental Exam
Vaccine and Immunizations
Record
Sexual Health
Diagnosed Injury and
Illness/Disease Tracker
PE Health Tracker
Sports Skills and Training Log
Heart Rate
Asthma
Deficiencies and Disease
Screening Parameters and
Components for Contagious or
Infectious or other Diseases such
as Cancer and Heart Disease
Diabetes
Medical Records
Medication Log
Sick day tracker
Additional Biometric Inputs:
Pain Scale
Sleep (daily hours)
Body Temperature
Pre and Post Natal Biometrics and
Recommendations
Age Group Recommended Health
Screenings
Physical Therapy/Rehabilitation
Allergies
Active Video game scores
Familial Tendencies

The fitness tests may change over time. The fitness test on the BDS may correspond to the President's Challenge as well as nationally accepted student fitness tests. An exemplary testing protocol requires a subject to engage in a series of exercises in which a series of repetitions are counted. For example, the tested person may be required to perform a Level 1 testing to a proficient level before proceeding to the next level. Upper body strength may be measured according to the following Levels: Level 1—kneeling plank with perfect posture for up to 60 seconds; Level 2—kneeling pushups or plank hold with perfect posture for up to 60 seconds; and Level 3—number of pushups with perfect posture for up to 60 seconds. Lower body strength may be measured according to the following Levels: Level 1—wall sits at 90 degrees with perfect posture for up to 60 seconds; Level 2—number of squats that touchdown to 90 degree depth marker with perfect posture for up to 60 seconds; and Level 3—number of squat hops, touching hand to the ground with perfect posture for up to 60 seconds.

Abdominal strength may be measured according to the following Levels, with stoppage of the exercise occurring if discomfort is felt in the subject's lower back: Level 1—number of crunches for up to 60 seconds; Level 2—number of upper/lower crunch combos for up to 60 seconds; and Level 3—number of full sit-ups for up to 60 seconds. Cardiovascular fitness is measured by the number of step-ups the subject is able to complete in 60 seconds. Flexibility may be measured by a seated reach for toes to measure hamstring and lower back flexibility, and by reaching to touch fingers behind head, one from top, one from bottom to test shoulder flexibility. Balance may be measured according to the following Levels: Level 1—Balance on one leg for up to 30 seconds; Level 2—balance on one leg with eyes closed for up to 30 seconds; and Level 3—balance in stork stance for up to 30 seconds.

Table 2, below, is illustrative of testing protocols that focus on mental, psychological or academic biometric parameters and performance measurements which can be applied to animate objects such as human beings, animals, and plants in accordance with the present teachings. Inputs of mental, psychological or academic biometric parameters may be obtained from various sources, including, for example, psychological assessments, academic testing data, or school records.

TABLE 2
Function/Exam/Test

Age Appropriate Stress Tests
Social Skills
Behavior Disorders
GPA
SAT/ACT Testing/All Standard
Test including IQ
Drivers Ed/Driving Record

Table 3, below, is illustrative of testing protocols that focus on nutritional information which can be applied to animate objects such as human beings, animals, and plants in accordance with the present teachings. Inputs of nutritional biometric parameters may be obtained from various sources, including, for example, user questionnaires, point-of-sale tracking systems, nutritional center data, etc.

TABLE 3
Function/Exam/Test

Track meal sales through POS System
Give nutrition tests/quizzes/Estimated Daily
Caloric Input and Output
Nutritional Analysis:
Serving sizes of meal components
Average calories in each meal
Distribution of food groups in each meal and
through a day
Hydration tracking: how much water intake on
average day
Nutritional Supplement Tracking
Feed your Character

Additional biometric information may be input from a wide variety of sources. For example, a school environmental survey may be employed to provide information concerning lunches provided and lunch options purchased, options in the vending machines, time between meals, duration of classes, average distance traveled between classes, traffic patterns within the school building, length and type of physical activity during the day, etc. Activity tracking devices may also be employed such as cardiovascular or heart rate monitoring devices, e.g., POLAR, GPS devices, pedometers, etc.

Specialized field information may also be tracked. For example, the BDS may include a sports recruiter page through which college and professional sports recruiters get all the information on one page of their potential recruits and are able to pull “athlete” pages and capture academic or behavioral information, physical performance statistics, current health statistics, training plans, improvements, weaknesses, nutrition plans and track trends and progress over a given time span, e.g., high school or college. The BDS may include a create team option in which the recruiter may package multiple athletes having complimentary skills to those athletes already on a team to address a given team's desired areas of improvement. Thus, for example, if a professional football team has traded for a new starting quarterback, but has an aging offensive line, the team may direct its recruiters and scouts to focus on interior offensive linemen to compliment the new starting quarterback.

The BDS may also be used to track information required by the military. For example, the BDS may assist in eligibility or induction screening by capturing and tracking all recruit information beginning on a specific date. The BDS may also be employed to receive input from Basic and AIT training, including, for example, training location, start date, graduation date, immunizations, drill instructor identification, paperwork completed (e.g., insurance, will, beneficiaries, etc.), PT Test scores and percentages, both when entered and when completed, height and weight when entered and when completed, meals eaten during training, tasks completed, courses completed (e.g., obstacle, road march distance, etc.), and/or yearly physical fitness test scores. The biometric display may dynamically change over time in response to changing data inputs, bonus amounts and payment dates, promotion events or tracking toward promotion events, and/or awards. A military uniform character may be employed to correctly represent the rank and awards of each serviceperson associated with the biometric display, including all proper rank indicators, pins, ribbons and placement of things on the uniform or which are part of the uniform, such as headwear, belts, braiding, etc. The biometric display may also include informational data, such as boot shining tips or packing instructions. Electronic medical records may be utilized as data input sources. Annual briefing information may be tracked, including the date, location, subject, and identity of the person giving the briefing. Other data that may be input into the BDS include: weapons qualification information, vehicle qualification information and inspection data, equipment qualification and inventories and medical benefit information.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computer-implemented method for delivering to a user a biometric display containing a graphic representation of the user that communicates health related information specific to the user, the method comprising steps of:
receiving, using a computer via a communication network, information associated with physical characteristics specific to the user and first health related information comprising user data specific to the user;
generating, using the computer, a biometric display of the user based on the received physical characteristics specific to the user, the biometric display presenting a virtual persona of the user using the received physical characteristics specific to the user to cause the virtual persona to look like the user;
generating, using the computer, health parameters based on the received physical characteristics or first health related information specific to the user, or both;
associating, using the computer, the health parameters with their respective body parts or areas on the biometric display, the health parameters communicating to the user the first health related information specific to the user regarding their respective body part on the biometric display;
delivering, to the user via the communication network, the biometric display along with the health parameters specific to the user, wherein the health parameters include active code flags or icons which can be activated using an input device;
setting, using the computer, a goal for the user, the goal being chosen by the computer and displayed on the biometric display;
generating, by the computer, a recommendation for the user of a behavior intended to advance the user toward the goal, the recommendation being chosen by the computer;
receiving, using the computer, second health related information comprising user data specific to the user;
tracking, using the computer, user progress toward the goal by comparing the second health related information to the first health related information;
updating the biometric display based on the second health related information; and
updating the progress indicator for the goal based on the tracking.

2. The method of claim 1, wherein receiving information associated with the physical characteristics specific to the user includes receiving from the user and over the communication network measurement information associated with gender, height, arm length, leg length, eye color, hair color, skin color, and/or weight specific to the user.

3. The method of claim 1, wherein the communication network includes an Internet.

4. The method of claim 1, wherein receiving the health related information specific to the user includes receiving from a health database and over the communication network the health related information specific to the user, the method further comprising receiving fitness performance related information specific to the user.

5-8. (canceled)

9. The method of claim 1, wherein the active code flags are color coded on a red-orange-yellow-green paradigm with a red color indicating a high health risk status or a poor health status, an orange color indicating moderate health risk status, a yellow color indicating a low to moderate risk status, and a green color indicating a good health status or a low risk status.

10. (canceled)

11. The method of claim 1, further comprising a step of generating a window, which provides additional detailed information about a particular active code flag selected by the user, the window including a first field displaying health risk factor associated with the particular active code flag selected by the user, a second field providing information about the health risk factor displayed in the first field, and a third field providing recommendations to the user for behavior modification relative to the health risk factor displayed in the first field.

12. The method of claim 1, wherein a first health parameter is associated with a first health risk, and the goal is chosen to reduce the first health risk.

13. (canceled)

14. A host system for delivering to a user a biometric display containing a graphic representation of the user that communicates health related information specific to the user, the host system comprising:
a processing device; and
a memory storing executable instructions for causing the processing device to:
receive, via a communication network, information associated with physical characteristics specific to the user and health related information comprising user data specific to the user;
generate a biometric display of the user based on the received physical characteristics specific to the user, the biometric display presenting a virtual persona of the user using the received physical characteristics specific to the user to cause the virtual persona to look like the user;
generate health parameters based on the received physical characteristics or first health related information specific to the user, or both;
associate the health parameters with their respective body parts or areas on the biometric display, the health parameters communicating to the user the first health related information specific to the user regarding their respective body part on the biometric display;
deliver, to the user via the communication network, the biometric display along with the health parameters specific to the user, wherein the health parameters include active code flags or icons which can be activated using an input device;
set a goal for the user, the goal being chosen by the computer and displayed on the biometric display;
generate a recommendation for the user of a behavior intended to advance the user toward the goal, the recommendation being chosen by the computer;
receive second health related information comprising user data specific to the user;
track user progress toward the goal by comparing the second health related information to the first health related information;
update the biometric display based on the second health related information; and
update the progress indicator for the goal based on the tracking.

15. The host system of claim 14, wherein to receive information associated with the physical characteristics specific to the user, the memory further stores executable instructions for causing the processing device to receive from the user and over the communication network measurement information associated with gender, height, arm length, leg length, eye color, hair color, skin color, and/or weight specific to the user.

16. The host system of claim 14, wherein the communication network includes an Internet.

17. The host system of claim 14, wherein to receive the health related information specific to the user, the memory further stores executable instructions for causing the processing device to receive from a health database and over the communication network the health related information specific to the user.

18-21. (canceled)

22. The host system of claim 14, wherein the active code flags are color coded on a red-orange-yellow-green paradigm with a red color indicating a high health risk status or a poor health status, an orange color indicating moderate health risk status, a yellow color indicating a low to moderate risk status, and a green color indicating a good health status or a low risk status.

23. (canceled)

24. The host system of claim 14, wherein the memory further stores executable instructions for causing the processing device to generate a window, which provides detailed information about a particular active code flag selected by the user, the window including a first field displaying health risk factor associated with the particular active code flag selected by the user, a second field providing information about the health risk factor displayed in the first field, and a third field providing recommendations to the user for behavior modification relative to the health risk factor displayed in the first field.

25. The host system of claim 14, wherein a first health parameter is associated with a first health risk, and wherein the goal is chosen to reduce the first health risk.

26-36. (canceled)

37. The method of claim 1, the tracking further comprising notifying the user regarding whether the user is on track to achieve the goal.

38. The host system of claim 14, wherein the memory further stores executable instructions for causing the processing device to notify the user regarding whether the user is on track to achieve the goal.
